(19) United States
(12) Patent Application Publication
(10) Pub. No.: US 2011/0297008 A1
(43) Pub. Date: Dec. 8, 2011

(54) COOKING EQUIPMENT

(75) Inventors: Ling Li, Shenzhen (CN); Ping Yan, Shenzhen (CN)

(73) Assignee: Xinyu LIN, Shenzhen (CN)

(21) Appl. No.: 13/056,414

(22) PCT Filed: Jul. 24, 2009
(86) PCT No.: PCT/CN09/72894

§ 371 Date: Aug. 24, 2011

(30) Foreign Application Priority Data
Jul. 30, 2008 (CN) 200810029877.8

(51) Int. Cl. A47J 27/00

(52) U.S. Cl. 99/324

(57) ABSTRACT

The present invention provides a cooking equipment comprising a pot, a body bracket, a rotation mechanism and a turning-over mechanism in which the pot is in shape of a barrel, a hemisphere or the like with an opening at its end, the rotation mechanism is connected to the pot to drive the pot to rotate around a rotation axis of the pot, the turning-over mechanism is connected to the pot to drive the pot to turn around a turning-over axis together with the body bracket, and when the cooking equipment is in its operating state, the angle between the rotation axis of the pot and horizontal plane is in the range of 0° to 90°.

### TECHNICAL FIELD OF THE PRESENT INVENTION

The present invention relates to kitchen utensils in the cooking filed, and more specifically to a cooking equipment.

### BACKGROUND OF THE PRESENT INVENTION

At present, Chinese dishes are still prepared manually by chef, which is not only detrimental to the health of the cooker, but also can not warrant the quality of Chinese dishes themselves.

Chinese patent application 02117497.0 disclosed an automatic pot used for frying dish and stewing soup. Computer controlling was employed in this application to make complex manual operations become automated operations. It possessed a series of functions such as feeding material, stir-frying, boiling, frying, adding seasoning ingredients, taking out finished dishes, pouring soup, washing pot, etc. Although this kind of automatic pot could rotate, it could rotate only along one direction, and the rotation could not be used to stir material. In addition, the direction of rotation would make the soup in the pot spill out easily if the pot was not covered tightly.

### SUMMARY OF THE PRESENT INVENTION

The object of the present invention is to provide a cooking equipment which can perform automatic or semi-automatic cooking process without the above-mentioned disadvantages. The cooking equipment of the present invention will not only save manpower and reduce manual operations of chef but also make materials inside a pot fully mixed.

To achieve the above-mentioned object the present invention employs a technical solution as following:

A cooking equipment comprises a pot, a body bracket, a rotation mechanism, and a turning-over mechanism in which the pot is in shape of a barrel, a hemisphere or the like with an opening at its end, the rotation mechanism is connected to the pot to drive the pot to rotate around a rotation axis of the pot, the turning-over mechanism is connected to the pot to drive the pot to turn around a turning-over axis together with the body bracket, and when the cooking equipment is in its operating state, the angle between the rotation axis of the pot and horizontal plane is in the range of 0° to 60°.

Preferably the pot is in shape of a barrel in order to make the pot have enough heating area during a heating process.

In addition the above described rotation axis of the pot means a line through the centers of the cross sections of the pot. The cross sections of the pot are generally in shape of a circle or a polygon. When the cross section of the pot is in shape of circle, the center of the cross section is the center of a circle, and when the cross section is in shape of a regular polygon, the center of the cross section is the center of its circum circle or its inscribed circle of the regular polygon.

The above described turning-over axis is an axis which has an angle with the rotation axis, and the angle is generally 90 degree.

The pot in the present invention further comprises a stirring mechanism installed inside the pot used for mixing. The stirring mechanism comprises a plurality of protrusions, baffles or ridges to make material inside the pot mixed when the pot is rotating.

When the stirring mechanism comprises a plurality of baffles the preferable number of the baffles is two. The baffles are perpendicular to the tangents of the internal surface of the pot, and there are arc transitions between the baffles and the internal surface. The baffles are so conFigured that when the baffles rotate together with the pot they will bring material inside the pot to higher positions and then throw it to lower positions to stir the material evenly.

The above described rotation mechanism comprises a driving mechanism and a connection mechanism connected to the pot. Preferably the driving mechanism is a motor. The connection mechanism can be a driving shaft, and can further comprise a connecting block. The connecting block is connected to the body of the pot. The pot is driven to rotate around its axis by the connecting block, which is driven to rotate by the motor through driving shaft.

The above described turning-over mechanism comprises a driving mechanism and a transmission mechanism, and the driving mechanism can drive the pot to turn over through the transmission mechanism. For example, the driving mechanism can be a motor, and the transmission mechanism can be a pot bracket. The motor drives the pot to turn over through the pot bracket.

The above described cooking equipment can further comprise a feeding mechanism. The feeding mechanism is positioned on the body bracket and above the pot. It comprises a transmission mechanism, a material-tank bracket and a material-tank. The transmission mechanism comprises a motor, transmission wheels and a transmission chain. The transmission chain is positioned at the transmission wheels. The transmission wheels are driven to rotate by the motor, and the transmission chain is driven to rotate by the transmission wheels. The material-tank is positioned in the material-tank bracket, and retaining notches are set on both sides of the material-tank bracket. The rocker arms of the material-tank is positioned in the retaining notches. A stop block is positioned on the back of the material-tank bracket, and this stop block is fixedly connected to the transmission chain.

The above described cooking equipment can further comprise a taking-out mechanism which is positioned at the body bracket. The taking-out mechanism comprises a taking-out container for taken out material. When a dish is finished, the pot is driven by the turning-over mechanism to turn over and material inside the pot is dumped into the taking-out container. Additionally, the taking-out mechanism can further comprise a translation mechanism on which the taking-out container is positioned. The translation mechanism is positioned on a sliding rail of the body bracket. The taking-out container can be taken out of the body bracket through the translation mechanism.

The above translation mechanism can be a joint moving mechanism connected to the pot bracket, or a translation mechanism driven by a motor. Preferably the translation mechanism is a joint moving mechanism. For example, a joint moving mechanism can comprise a base bracket, slide blocks, a connecting plate, a connecting pillar and a connecting rod. The number of slide blocks can be four, which are positioned on four legs under the base bracket respectively. The slide blocks are on the sliding rail of the body bracket. The connecting plate is vertically positioned at one leg of the base bracket. The connecting pillar is positioned at the upper end of the connecting plate. One end of the connecting rod is connected to the connecting pillar, and the other end is connected to the pot bracket. The taking-out container is positioned at the base bracket. When the pot and the pot bracket is driven to turn over by the turning-over mechanism, the base bracket is driven to move backward by the connecting rod, and thus material inside the pot in dumped into the taking-out container.

The above described cooking equipment can further comprise a supplying mechanism which is positioned on the body bracket. The supplying mechanism can supply other material or resource needed by a cooking process or the cooking equipment. For example, the supplying mechanism can be an oil injecting mechanism. The oil injecting mechanism is positioned above the pot, and can inject edible oil from an oil tank to the pot by controlling a valve in a oil pipe. Additionally, the supplying mechanism can be a water injecting mechanism. The water injecting mechanism can supply water resource used for washing the pot, and can inject water from a water tank to the pot by controlling a valve in a water pipe.

With the cooking equipment of the present invention all cooking steps, including feeding material, stirring material, and taking out material, can be realized automatically. Furthermore, the pot has two freedoms of motion, which can make the pot rotate and turn over to reach respectively the aims of stirring evenly and taking-out material automatically. Compared to prior art, the cooking equipment of the present invention can easily control a cooking duration and perform a cooking process automatically or semi-automatically.

### BRIEF DESCRIPTION OF THE DRAWINGS

The embodiment of present invention will be described in details in conjunction with the attached Figures. However, although the present invention is described through specific embodiments, it is appreciated that skilled one in the art could make many modifications and variations in view of teachings of the present invention. The embodiment herein are not intended to limit the scope of the present invention.

FIG. 1 is an explosive schematic view of a cooking equipment in an embodiment according to the present invention.

FIG. 2 is a structure schematic view of a rotation mechanism and a pot bracket in an embodiment according to the present invention.

FIG. 3 is a structure schematic view of an automatic feeding mechanism in an embodiment according to the present invention.

FIG. 4 is a structure schematic view of a taking-out mechanism in an embodiment according to the present invention.

FIG. 5 is a schematic view of a cooking equipment which is in feeding state according to the present invention.

FIG. 6 is a schematic view of a cooking equipment which is in cooking state according to the present invention.

FIG. 7 is a schematic view of a cooking equipment which is in a state of material being taken out according to the present invention.

FIG. 8 is a structure schematic view of a cooking equipment in another embodiment according to the present invention.

### DETAILED DESCRIPTION OF THE EMBODIMENTS

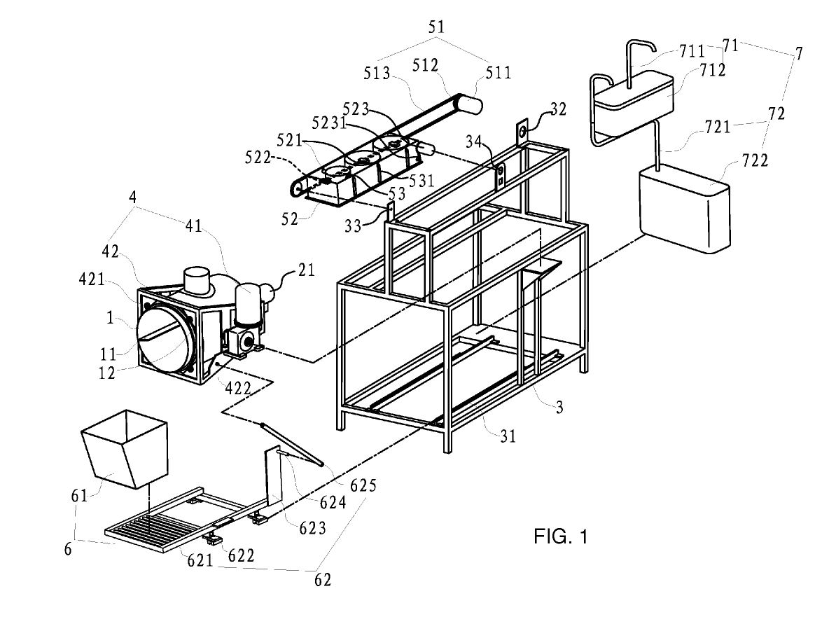

Please refer to FIG. 1, an explosive schematic view of a cooking equipment in an embodiment according to the present invention. The cooking equipment disclosed in FIG. 1 comprises a pot 1, a rotation mechanism 2, a body bracket 3, a turning-over mechanism 4, a feeding mechanism 5, a taking-out mechanism 6 and a supplying mechanism 7.

The pot 1 is in shape of a barrel, whose cross section is in shape of a circle. It has an opening at its end. A stirring mechanism is installed inside the pot 1. The stirring mechanism is two baffles 11 inside the pot 1. The baffles 11 are perpendicular to the tangent of the internal surface of the pot 1, and there is arc transitions between the baffles 11 and the internal surface. The baffles 11 are so conFigured that when the baffles 11 rotate together with the pot 1 they will bring the material inside the pot 1 to higher positions and then throw the material to lower positions to stir the material evenly.

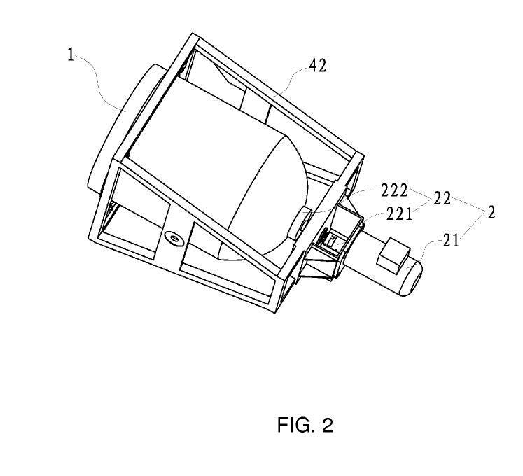

Refer now to FIG. 2, in which a rotation mechanism 2 comprises a driving mechanism and a connection mechanism 22 connected to a pot 1. The driving mechanism is motor 21. The connection mechanism 22 consists of a driving shaft 221 and a connecting block 222. The connecting block 222 is connected to the bottom of the pot 1. The pot 1 is driven to rotate around its axis by the connecting block 222, which is driven to rotate by the motor 21 through the driving shaft 221.

The turning-over mechanism 4 comprises a driving mechanism 41 and a pot bracket 42. The driving mechanism 41 can be a motor, it can drive the pot 1 to turn over through pot bracket 42. The pot bracket 42 is installed on the body bracket 3.

The rotation mechanism 2 is positioned beneath the pot bracket 42.

A sliding rail 12 is positioned on the upper surface of the pot 1, and correspondingly, pulleys 421 are positioned at the pot bracket 42. When the pot 1 is driven to rotate around its axis by the rotation mechanism 2, the sliding rail 12 and the pulleys 421 will give a support for such a rotating.

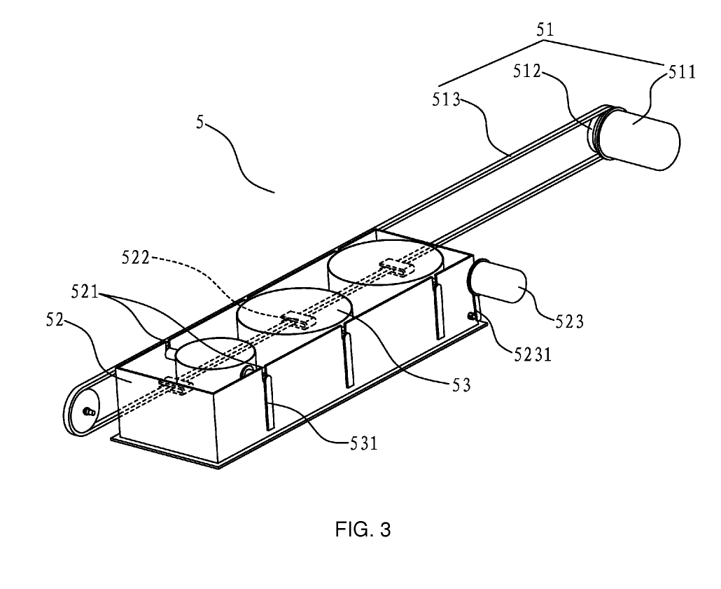

Refer now to FIG. 3, in which the feeding mechanism 5 is positioned at the body bracket 3 and above the pot 1. It comprises a transmission mechanism 51, a material-tank bracket 52 and a material-tank 53. The transmission mechanism 51 comprises a motor 511, transmission wheels 512 and a transmission chain 513. The transmission chain 513 is positioned at the transmission wheels 512. The motor 511 is positioned at the body bracket 3 through the location hole 32 on the upper of the body bracket 3. The shaft of one of the transmission wheels 512 passes through the location hole 32, the shaft of another of the transmission wheels 512 passes through another location hole 33 of the body bracket 3. The transmission wheels 512 are driven to rotated by the motor 511, and the transmission chain 513 is driven to rotate by the transmission wheels 512. The material-tank 53 is positioned in the material-tank bracket 52, and retaining notches 521 are positioned at both sides of the material-tank bracket 52. The rocker arms 531 of the material-tank 53 are positioned in the retaining notches 521. Stop blocks 522 are positioned on the back of the material-tank bracket 52, and the stop blocks 522 are fixedly connected to the transmission chain 513.

A motor 523 is positioned on the side of the material-tank bracket 52 which also has retaining notches 521. The motor 523 is positioned at the location hole 34 on the upper of the body bracket 3, which comprises a handle rotating around its output shaft.

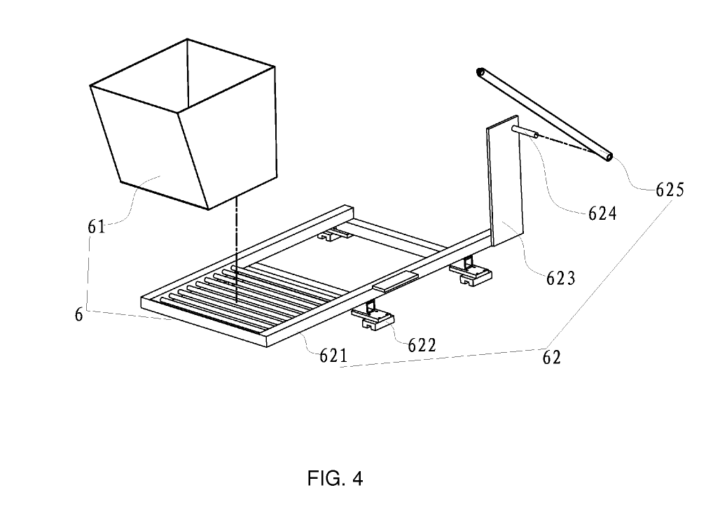

Refer to FIG. 4 in which the taking-out mechanism 6 comprises a taking-out container 61 and a translation mechanism 62. The translation mechanism 62 comprises a base bracket 621, four slide blocks 622, a connecting plate 623, a connecting pillar 624 and a connecting rod 625. The four slide blocks 622 are positioned respectively on four legs under the base bracket 621. The slide blocks 622 are positioned in the sliding rail 31 of the body bracket 3. The connecting plate 623 is positioned vertically at one leg of the base bracket 621. The connecting pillar 624 is positioned at the upper end of the connecting plate 623. One end of the connecting rod 625 is connected to the connecting pillar 624, and the other end is connected to the pin 422 of the pot bracket 42. The taking-out container 61 is positioned at the base bracket 621. When the pot 1 and the pot bracket 42 is driven to turn over by the turning-over mechanism 4, the base bracket 621 is driven to move backward by the connecting rod 625 to make the material inside the pot 1 dumped into the taking-out container 61.

Refer to FIG. 1. The supplying mechanism 7 is positioned on the body bracket 3. The supplying mechanism 7 comprises an oil injecting mechanism 71, and a water injecting mechanism 72. The oil injecting mechanism 71 is positioned above the pot 1, and injects edible oil from an oil tank 711 to the pot 1 by controlling a valve in an oil pipe 711. The water injecting mechanism 72 can supply water resource used for washing the pot 1, and inject water from a water tank 721 to the pot 1 by controlling a valve in a water pipe 722.

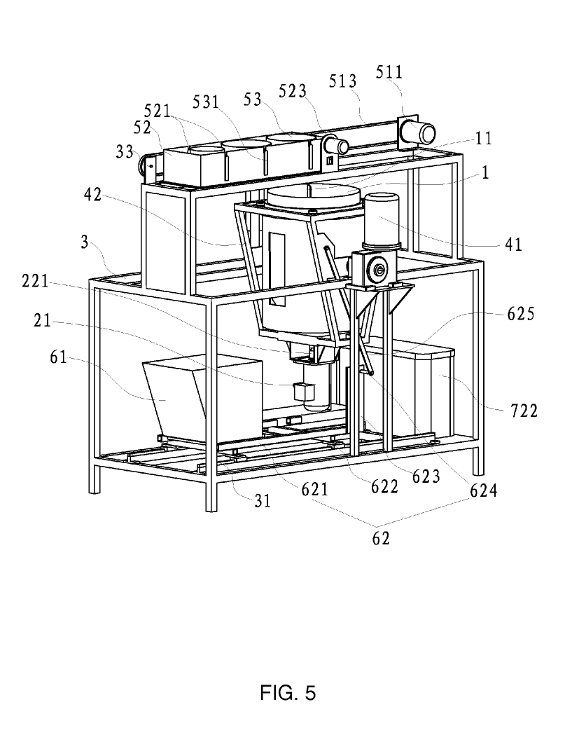

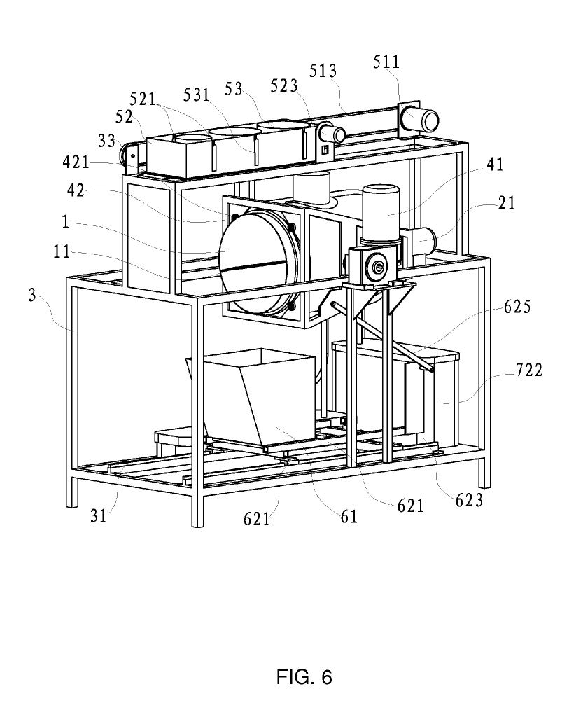

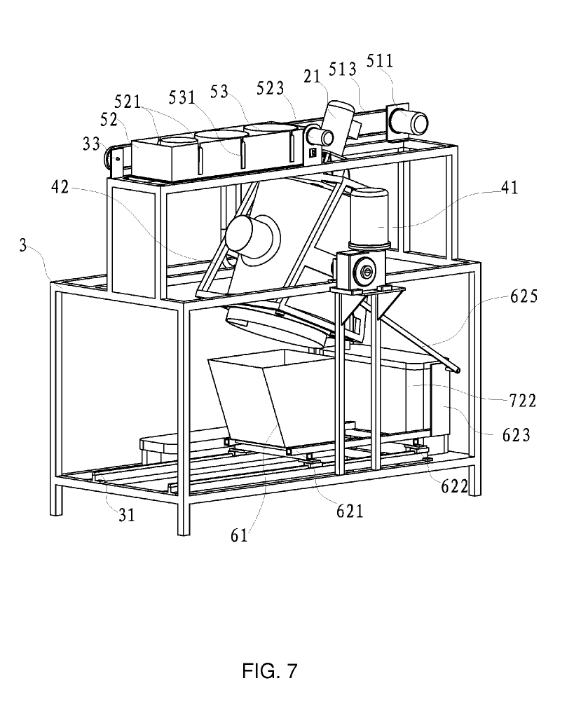

Refer to FIG. 5. At the beginning, material is put into the pot 1 by the feeding mechanism 5, and at this moment, the pot 1 is substantially vertical. The material-tank bracket 52 moves to the position above the pot 1 driven by the transmission mechanism 51. The rotation of motor 523 drives handle 5231 to rotate, and the rotation of the handle 5231 drives the rocker arm 531 of material-tank 53 to rotate, and the rotation of the rocker arm 531 drives the material-tank 53 to rotate around the axis of the rocker arm 531, and the material inside the material-tank 53 is dumped into the pot 1. Then the pot 1 turns to the position shown as FIG. 6 driven by the turning-over mechanism 4. At this moment, the angle between the axis of the pot 1 and the horizontal plane is 5 degree, and the pot 1 is heated by a heating mechanism while the pot 1 rotates around its own axis driven by the rotation mechanism 2. The material inside the pot 1 is stirred by the baffles 11. After a kind of dish is finished, the pot 1 continues to turn over driven by the turning-over mechanism (shown as FIG. 7). The base bracket 621 moves backward driven by connecting rod 625, making the taking-out container 61 on the base bracket 621 move to the position ahead of the pot 1, and then the material inside the pot 1 is dumped into the taking-out container 61. Then the pot 1 turns back, and the taking-out mechanism moves forward down the sliding rail 31 of the body bracket 3, and then the taking-out container 61 is taken out. Finally, when the pot 1 needs to be washed, water is pumped by water injecting mechanism 72 from water tank to wash the pot 1.

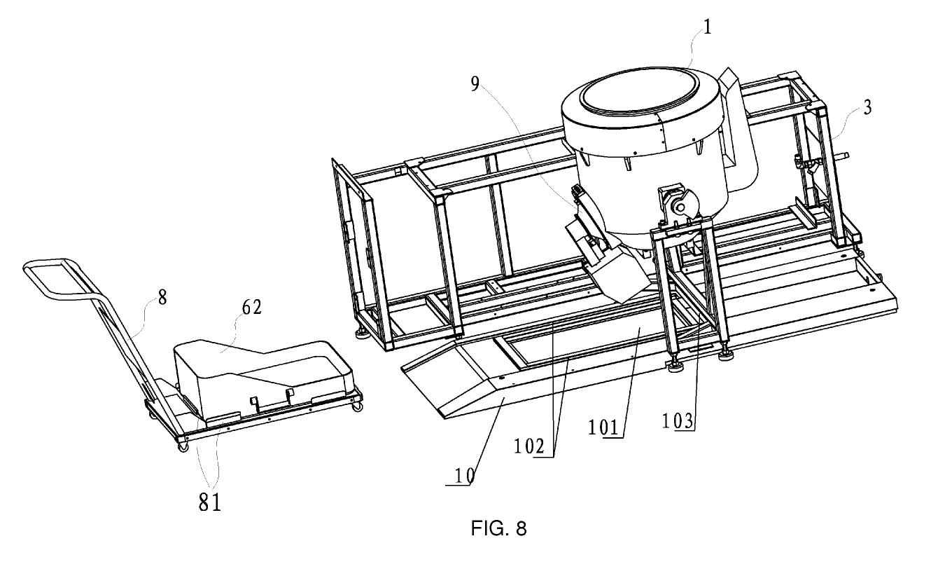

Refer to FIG. 8. Compared with the embodiment in FIG. 1, the cooking equipment in this embodiment further comprises a material transferring mechanism 8, a heating mechanism 9 and a material accepting mechanism 10, in which:

The material transferring mechanism 8 is a cart-structure, and the cart-structure can be a belt or chain transferring structure.

The material transferring mechanism 8 comprises a stop block 81, which is used to prevent relative movement between the taking-out container 62 and the material transferring mechanism 8.

The material accepting mechanism 10 is positioned beneath the pot 1. The material accepting mechanism 10 comprises a material accepting tank 101, a guiding part 102 and a stop block 103, in which the material accepting tank 101 is against the opening of the pot 1.

The pot 1 is surrounded by an insulation layer 13. A heating mechanism 9 is positioned on the insulation layer 13. During a cooking process the heating mechanism 9 can rotate together with the insulation layer 13.

During operation the taking-out container 62 is moved to the position beneath the pot 1 by the material transferring mechanism 8. And after the material inside the pot 1 is taken out, the taking-out container 62 is transferred to a pre-determined position.

In still another embodiment of the present invention its only difference from the above is that the angle between the axis of the pot 1 and the horizon is 15 degree.

In yet another embodiment of the present invention its only difference from the above is that the angle between the axis of the pot 1 and the horizon is 35 degree.

In yet another embodiment of the present invention its only difference from the above is that the angle between the axis of the pot 1 and the horizon is 60 degree.

In yet another embodiment of the present invention its only difference from the above is that the angle between the axis of the pot 1 and the horizon is 85 degree.

1. A cooking equipment comprising a pot, wherein said cooking equipment further comprises a body bracket, a rotation mechanism, and a turning-over mechanism, in which said pot is in shape of a barrel, a hemisphere or the like with an opening at its end, said rotation mechanism is connected to said pot to drive said pot to rotate around a rotation axis of said pot, said turning-over mechanism is connected to said pot to drive said pot to turn around a turning-over axis on said body bracket, and when said cooking equipment is in its operating state, the angle between said rotation axis of said pot and horizontal plane is in the range of 0° to 90°.

2. The cooking equipment of claim 1, wherein the cross section of said pot perpendicular to the rotation axis is in shape of a circle or a polygon.

3. The cooking equipment of claim 1, further comprising a stirring mechanism installed inside said pot for mixing.

4. The cooking equipment of claim 3, wherein said stirring mechanism is a plurality of protrusions, baffles or ridges.

5. The cooking equipment of claim 1, wherein said rotation mechanism comprises a driving mechanism and a connection mechanism which is connected to said pot.

6. The cooking equipment of claim 1, wherein said turning-over mechanism comprises a driving mechanism and a transmission mechanism in which said driving mechanism drives said pot to turn over through said transmission mechanism.

7. The cooking equipment of claim 1, further comprising a feeding mechanism which is positioned on said bracket and above said pot.

8. The cooking equipment of claim 1, further comprising a taking-out mechanism which is positioned on said bracket.

9. The cooking equipment of claim 8, wherein said taking-out mechanism comprises a taking-out container for taken out material.

10. The cooking equipment of claim 9, wherein said taking-out mechanism further comprises a translation mechanism in which said taking-out container is positioned on said translation mechanism and said translation mechanism is positioned on the leading rail of said bracket.

11. The cooking equipment of claim 1, further comprising a supplying mechanism which is positioned on said bracket.

12. The cooking equipment of claim 11, wherein said supplying mechanism is an oil injecting mechanism, which is above said pot and used for injecting oil from an oil tank to said pot by controlling a valve in oil pipe.

13. The cooking equipment of claim 11, wherein said supplying mechanism is an water injecting mechanism, which is used for injecting water from a water tank to said pot by controlling a valve in water pipe.

14. The cooking equipment of claim 1, wherein the angle between said rotation axis and said turning-over axis is 90°.

15. The cooking equipment of claim 1, further comprising a material transferring mechanism and a taking-out container in which said taking-out container is positioned on said material transferring mechanism, and said taking-out container is transferred to the position beneath said pot when material is being taken out and transferred to a pre-determined position after material has been taken out.

16. The cooking equipment of claim 15, wherein said material transferring mechanism further comprises a stop block which is used to prevent relative movement between said taking-out container and said material transferring mechanism.

17. The cooking equipment of claim 15, wherein said material transferring mechanism is built in a cart-structure.

18. The cooking equipment of claim 15, further comprising a material accepting mechanism which is beneath the pot.

19. The cooking equipment of claim 18, wherein said material accepting mechanism has a material accepting tank which can be against the opening of said pot.

20. The cooking equipment of claim 15, further comprising a guide part and/or a stop block which is cooperated with said material transferring mechanism.

21. The cooking equipment of claim 15, wherein said pot is surrounded by a insulation layer.

22. The cooking equipment of claim 22, wherein a heating mechanism is positioned on said insulation layer.
